(19) United States
(12) Patent Application Publication
(10) Pub. No.: US 2007/0291198 A1
(43) Pub. Date: Dec. 20, 2007

(54) Method and device for driving LED-based backlight module

(75) Inventor: Yuh-Ren Shen, Hsinchu (TW)

Correspondence Address: BIRCH STEWART KOLASCH & BIRCH, PO BOX 747, FALLS CHURCH, VA, 22040-0747, US

(73) Assignee: VastView Technology Inc.

(21) Appl. No.: 11/453,934

(22) Filed: Jun. 16, 2006

(51) Int. Cl. G02F 1/1335

(52) U.S. Cl. 349/69

(57) ABSTRACT

A device and a related device for driving LED-based, direct-lit backlight modules are provided. The device contains a driver controller which receives the timing signals from the display device and a number of drivers which is series-connected or parallel-connected to the driver controller. Each of the drivers is activated by the driver controller to drive a number of LEDs of the backlight module by current pulses. Each driver automatically detects its output current or voltage and increases the duty cycle of the current pulses so as to compensate the brightness loss from out-of-work LEDs. The method delivers pulses of different pulse counts in a fixed period of time (e.g., a frame time) to the red-, green-, and blue-light LEDs so as to achieve a constant color temperature based on their different response to the temperature.

### BACKGROUND OF THE INVENTION

1. Field of the Invention

The present invention generally relates to backlight modules for display devices, and more particularly to a device and a related method for driving the light emitting diodes of a direct-lit backlight module.

2. The Prior Arts

Currently, most backlight modules for large-sized liquid crystal displays (LCDs) or LCD TVs adopt a direct-lit approach using either cold cathode fluorescent lamps (CCFLs) or light emitting diodes (LEDs) as light source. As the CCFLs suffer potential environmental issues from the mercury vapor contained in the lamp tubes, while the LEDs have been advanced to provide superior switching speed, lighting efficiency, and cost, LEDs have become the main stream light source for LCDs. FIG. 1a is a schematic diagram showing a conventional LED-based, direct-lit backlight module. As illustrated, multiple LEDs are arranged in an array in front of a reflection plate. These LEDs could be white-light LEDs, or red-, green-, or blue-light LEDs in various combinations. Usually, there are diffusion sheets and prism sheets in front of the LEDs for enhancing the uniformity and brightness of light projected to the LCD panel.

One major drawback of the LED-based, direct-lit backlight module is that there is always some difference between the brightness of the individual LEDs. When red-, green, and blue-light LEDs are used as light source, such difference is especially obvious and therefore it is difficult to control the color temperature of the white light produced by these colored LEDs. Additionally, as shown in FIG. 1b, the variation of the brightness along with the temperature is also different among different colored LEDs. Therefore, after a period of usage and as the temperature rises, the variance of the brightness of the LED would increase. For example, as the temperature rises from room temperature to a temperature T, the brightness of the red-light LED (R) has the largest degree of degradation while the blue-light LED (B) and the green-light LED (G) would have less and least amount of degradation. Therefore, the uniformity of the brightness and color temperature of the LED-based, direct-lit backlight module could be easily affected by the variation of the individual LEDs. Though the diffusion sheet is effective in smoothing out the difference, the improvement is still limited. When one or more LEDs are broken or the difference between these LEDs and the rest of LEDs reaches a certain level, such difference would still be visible.

### SUMMARY OF THE INVENTION

Accordingly, the present invention provides a device and a related device for driving LED-based, direct-lit backlight modules so as to obviate the foregoing shortcomings.

The proposed device contains a driver controller which receives the timing signals from the display device and a number of drivers which is series-connected or parallel-connected to the driver controller. Each of the drivers is activated by the driver controller to drive a number of LEDs of the backlight module by current pulses. The duty cycle and the pulse count within a period of time (e.g., a frame time) of the current pulses are adjustable dynamically. Each driver automatically detects its output current or voltage and, in a constant-current or constant-voltage manner, increases the duty cycle of the current pulses so as to compensate the brightness loss from out-of-work LEDs by increasing the brightness of other working LEDs.

The proposed method is implemented in the control circuit of the driver controller and the control units of the drivers. The method provides a constant color temperature by delivering pulses of different pulse counts in a fixed period of time to the red-, green-, and blue-light LEDs so as to control their brightness respectively. In addition, by the feedback of temperature sensors, the drivers can individually adjust the pulse counts to the various colored LEDs based on their different response to the temperature so as to maintain a constant color temperature.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing a conventional LED-based, direct-lit backlight module.

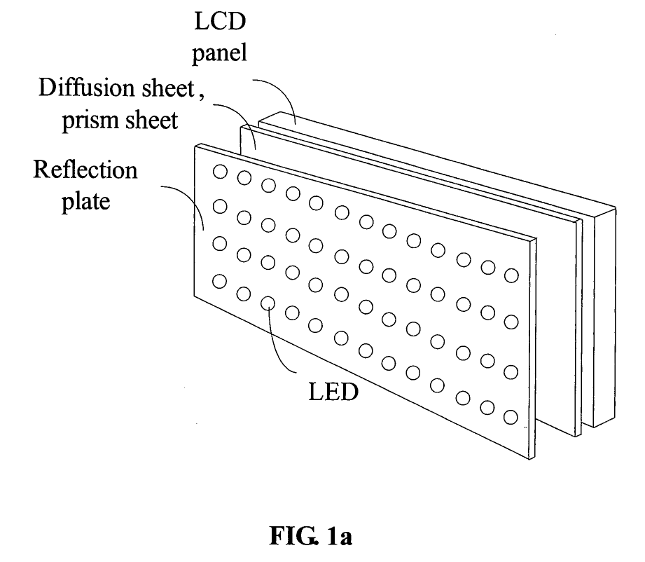

FIG. 1b is a graph showing the brightness degradation of the red-, green-, and blue-light LEDs as the temperature rises.

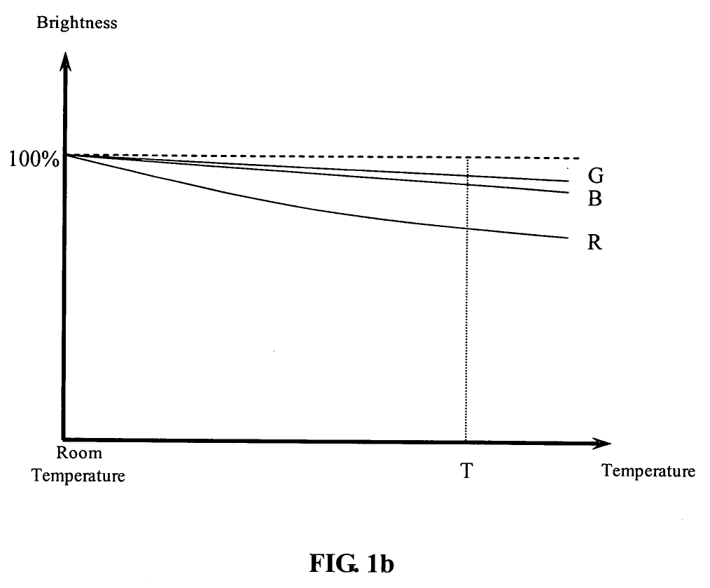

FIG. 2a is a schematic diagram showing the configuration of the driver controller and the drivers according to a first embodiment of the present invention.

FIG. 2b is a schematic diagram showing the configuration of the driver controller and the drivers according to a second embodiment of the present invention.

FIG. 3a is a schematic diagram showing the driving circuit of the present invention.

FIG. 3b is a schematic diagram showing the driving circuit according to a constant-voltage embodiment of the present invention.

FIG. 3c is a schematic diagram showing the driving circuit according to another constant-voltage embodiment of the present invention.

FIG. 3d is a schematic diagram showing the driving circuit according to a constant-current embodiment of the present invention.

FIG. 4a is a schematic diagram showing the functional blocks of the driver according to an embodiment of the present invention.

FIG. 4b is a schematic diagram showing the driver controller in a series connection scheme.

FIG. 4c is a schematic diagram showing the driver controller in a parallel connection scheme.

FIG. 5a is a schematic diagram showing the partition of the temperature range into a number of segments according to the present invention.

FIG. 5b is a schematic diagram showing the switching pulses corresponding to the temperature segments of FIG. 5a supplied to the switch on the path to red-light LEDs.

FIG. 5c is schematic graph showing the adjustment of the duty cycle of the switching pulse (i.e., the vertical axis) versus the temperature variation (i.e., the horizontal axis).

FIG. 5d is a schematic diagram showing a number of variations of the adjustment of the duty cycle of the switching pulses using a hysteresis approach.

FIG. 6a is a schematic diagram showing the generation of white light of a high color temperature according to the present invention.

FIG. 6b a schematic diagram showing the generation of white light of a low color temperature according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a device and a related method for driving a direct-lit backlight module using multiple LEDs as light source. The backlight module could be one for a LCD device, a plasma display device, or an organic light-emitting display (OLED) device. For simplicity, the following description mainly uses a LCD device as example.

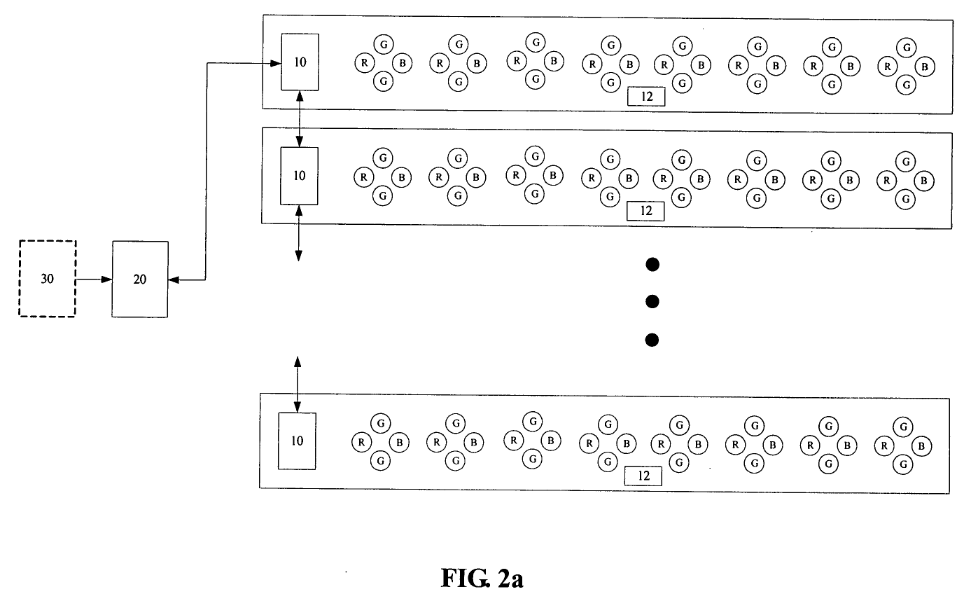

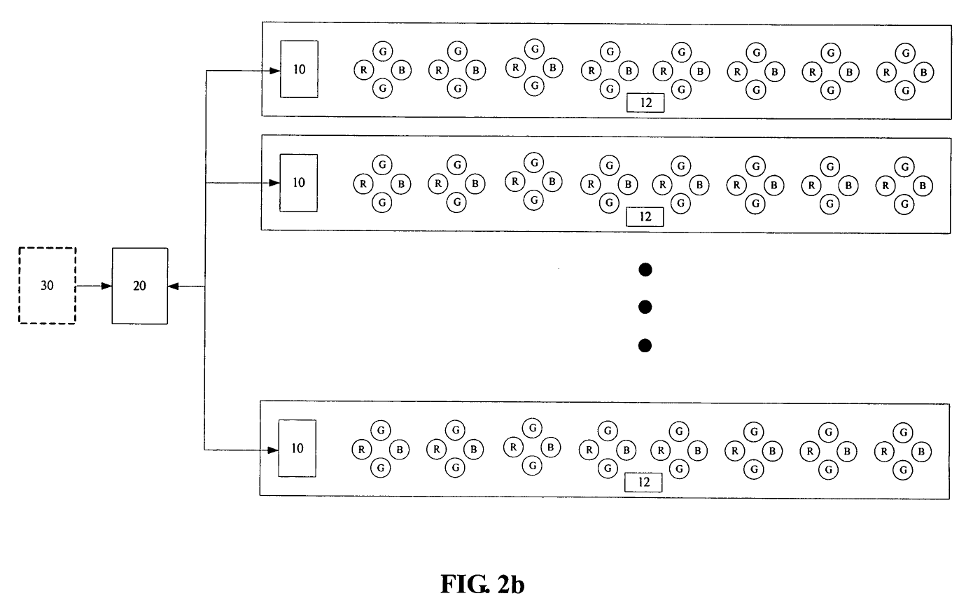

The device mainly contains a driver controller and a number of drivers. Each driver in turn controls a portion of the LEDs of the backlight module. FIG. 2a is a schematic diagram showing the configuration of the driver controller and the drivers according to a first embodiment of the present invention. As illustrated, each controller 10 is responsible for a horizontal line of sets of LEDs. Each set of LEDs contains a red-light (R) LED, a blue-light LED (B), and two green-light LEDs (G). Please note that the configuration of the LEDs shown in FIG. 2a is only exemplary; various other configurations, color combinations, and numbers of LEDs can also be adopted. On the other hand, the driver controller 20 receives various timing signals such as Vsync, DE, DCLK from the timing controller 30 of the LCD device, and then, via the series-connection configuration shown in FIG. 2a, provides control signals to the drivers 10 stage by stage. FIG. 2b is a schematic diagram showing the configuration of the driver controller and the drivers according to a second embodiment of the present invention. As illustrated, the drivers 10 and the driver controller 20 are in a parallel-connection configuration and the driver controller 20 provides control signals to the drivers 10 simultaneously. Please note that the connection between the driver controller 20 and the drivers 10 is not limited to series connection or parallel connection. A combination of series and parallel connections or other manners of connections can be adopted as well. Furthermore, the driver controller 20 can also simultaneously control the drivers 10 via series connection; or the driver controller 20 can also control the drivers 10 in sequence via parallel connection

Each driver 10 applies periodic current pulses to its connected LEDs and, by altering the duty cycle and the pulse count within a period of time (e.g., a frame time), each driver 10 is able to achieve (1) automatic brightness compensation for out-of-work LEDs; (2) constant color temperature; and (3) automatic compensation for LED brightness degradation from increased temperature.

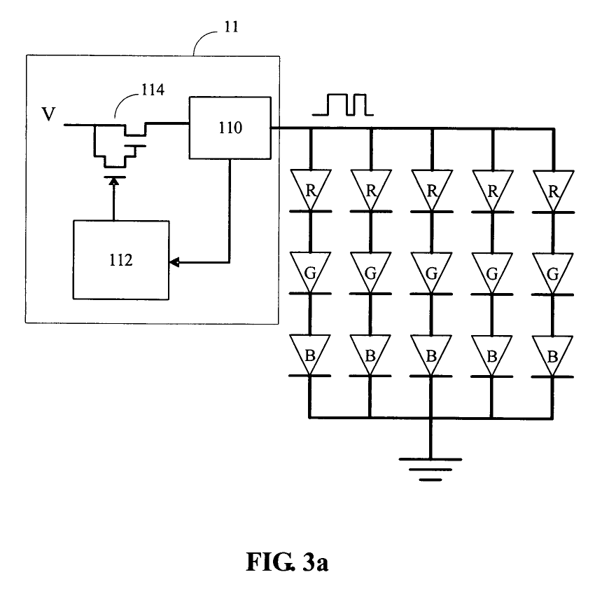

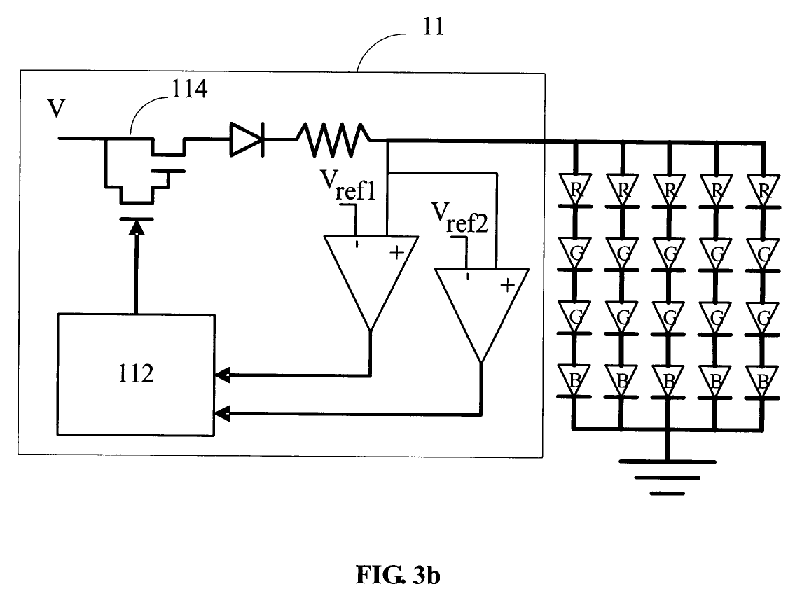

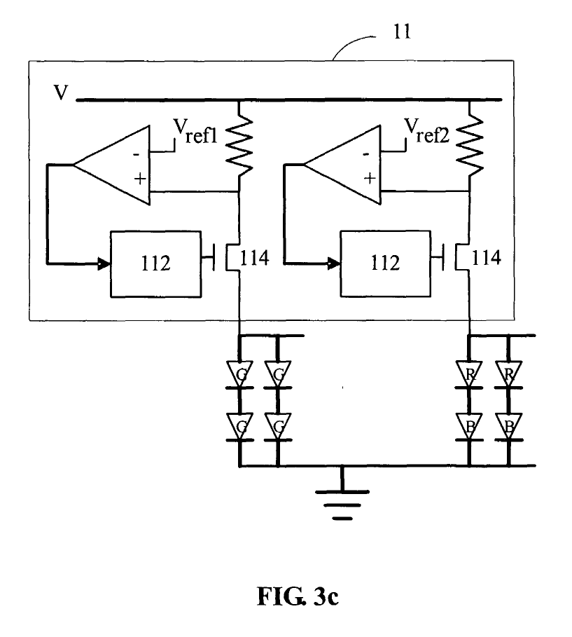

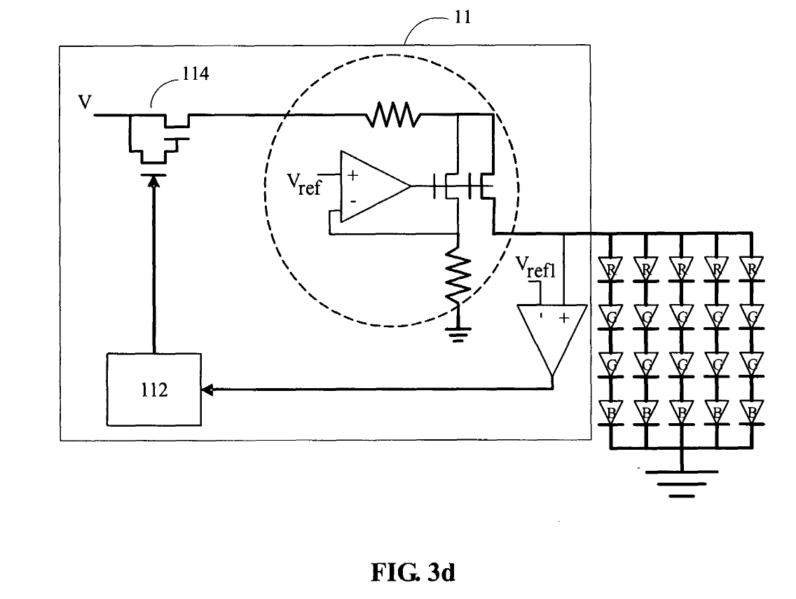

The current pulses are provided by a driving circuit 11 of the driver 10, which will automatically alter the duty cycle of the current pulses when some LEDs are out of work. FIG. 3a is a schematic diagram showing the driving circuit of the present invention. As shown, the driving circuit 11 has at least a current output path and the sets of LEDs are arranged along the current output paths respectively. For example, in the diagram, five sets of LEDs, each having a red-light LED, a green-light LED, and a blue-light LED in series connection, are parallel-connected to a current output path. The driving circuit 11 contains a current feedback circuit 110, a pulse width controller 112, and an electronic switch 114. When one LED in the five sets of LEDs is broken and causes an open circuit, the pulse width controller 112 will detect the drop of current output from the current feedback circuit 110. The pulse width controller 112 then can adjust the electronic switch 114 to produce current pulses of a larger duty cycle. The other four sets of LEDs therefore would receive larger driving current to produce brighter light so as to compensate the brightness loss. If additional sets of LEDs are not working, the driving circuit 11 would function identically to raise the brightness of the other working sets of LEDs.

The driving circuit can work in a constant-current manner or a constant-voltage manner. FIG. 3b is a schematic diagram showing the driving circuit according to a constant-voltage embodiment of the present invention. As illustrated, the current feedback circuit 110 contains two differential amplifier to provide three ranges of operation based on two reference voltages Vref1 and Vref2 (Vref1>Vref2). When the sensed voltage is greater than Vref1m implying all sets of LEDs are working, the pulse width controller 112 causes the current pulses to have a default duty cycle (e.g., 50%). When the sensed voltage is less than Vref1 but greater than Vref2, implying a set of LEDs is not working, the pulse width controller 112 causes the current pulses to have a larger duty cycle (e.g., 70%). When the sensed voltage is less than Vref2, implying an additional set of LEDs is not working, the pulse width controller further increases the duty cycle of the current pulses (e.g., 90%). Based on the same principle, the present embodiment could be equipped with more differential amplifiers to achieve finer control. FIG. 3c is a schematic diagram showing the driving circuit according to another constant-voltage embodiment of the present invention. The operation principle of the present embodiment is identical to the one shown in FIG. 3b except that there are two current output paths, each connected to LEDs of different color combinations. The current pulses on these current output paths are adjusted separately and individually. In other words, the LEDs controlled by a driver are separated into a number of sets, each having a number of LEDs of appropriate color combinations. These sets of LEDs are parallel-connected to the driver by at least a current output path. The driver applies separate current pulses though these current output paths to the sets of LEDs arranged along these current output paths.

The driving circuit 11 can also operate in a constant-current manner. FIG. 3d is a schematic diagram showing the driving circuit according to a constant-current embodiment of the present invention. What is shown in the dashed circle is a current mirror circuit, which should be quite familiar to persons skilled in the related arts and whose details are therefore omitted here.

The foregoing embodiments achieve automatic compensation to cover the brightness loss from defect LEDs using feedback control of the duty cycle of the driving pulses. The principle can be further applied to control the color temperature and to smooth out the brightness variance resulted from temperature variation. The basic idea is that, if different driving pulses are provided to different colored LEDs, supplying driving pulses of different pulse counts within a fixed period of time, for example a frame time, would alter the brightness of different colored LEDs and therefore a desired color temperature can be achieved. Additionally, the pulse counts can further be determined based on the response of various colored LEDs to the temperature so that, even under different temperature, the desired color temperature can be maintained. The two types of control can be implemented separately or jointly.

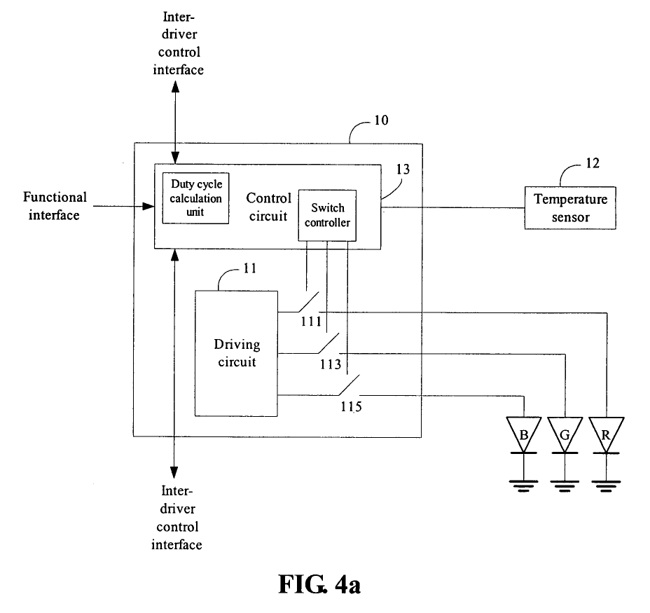

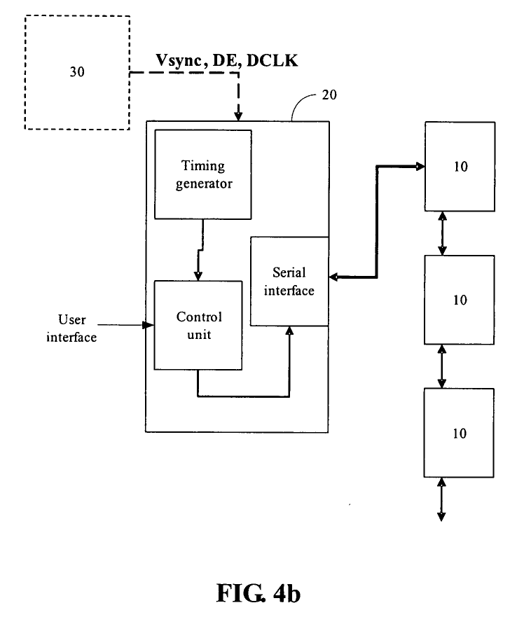

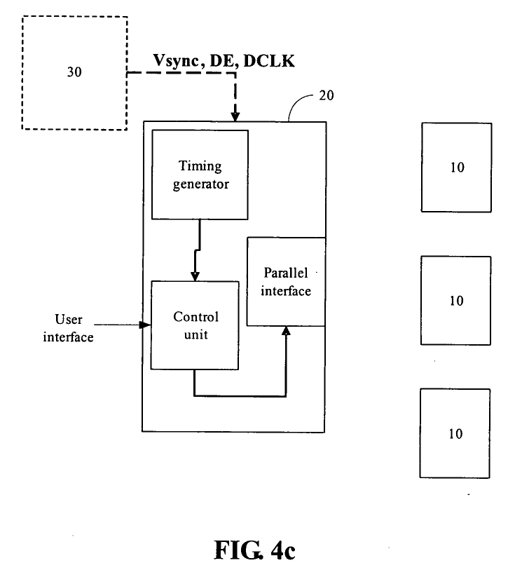

FIG. 4a is a schematic diagram showing the functional blocks of the driver according to an embodiment of the present invention. In the diagram, the drivers 10 are cascaded in series as shown in FIG. 2a through the inter-driver control interface. As illustrated, the driver 10 contains a control circuit 13 and a temperature sensor 12 (also see FIGS. 2a and 2b) within appropriate proximity of the LEDs controlled by the driver 10, in addition to the foregoing driving circuit 11. The LEDs controlled by the driver 10 are separated into three sets based on their light colors, each driven by a separate current output path from the driving circuit 11. Along the current output paths, switches 111, 113, and 115 controllable by a switch controller of the control circuit 13 are provided respectively. With this configuration, the driving pulses produced by the driving circuit 11 would be supplied to the LEDs intermittently as the switches 111, 113, and 115 are turned on and off by the control circuit 13.

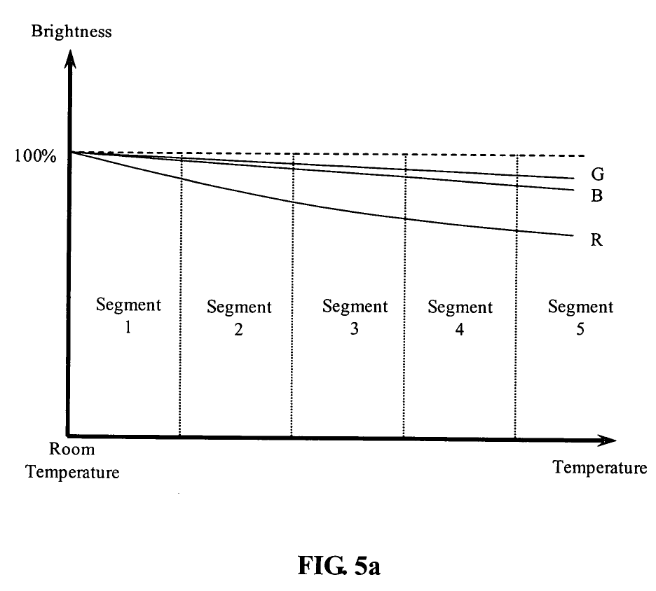

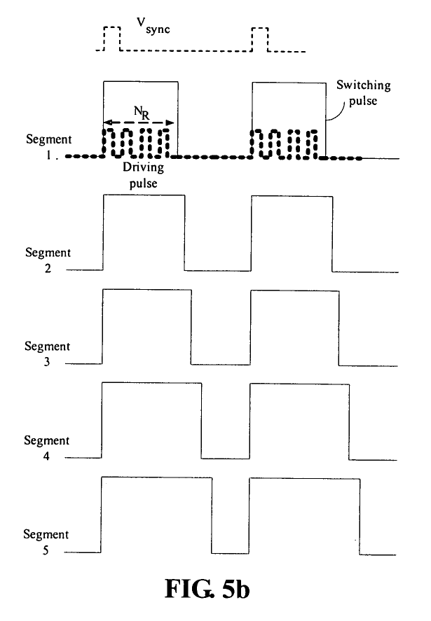

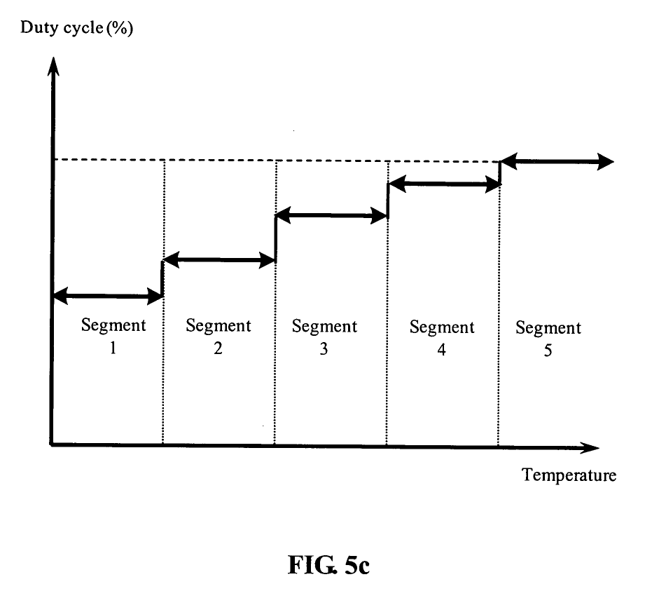

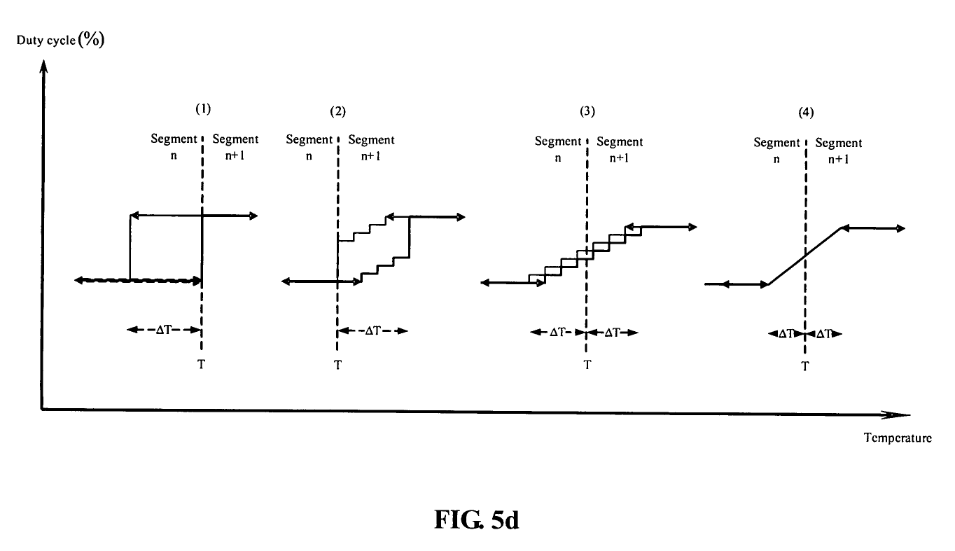

In the following, how to resolve the brightness variance resulted from temperature variation is described first. First of all, from the temperature sensor 12, the control circuit 13 is able to know the current temperature and, then, the control circuit 13 turns on and off the switches 111, 113, and 115 according to the method provided by the present invention. The method partitions the range of temperature into a number of segments (e.g., five segments in the present embodiment). Then, based on the segment of the current temperature, the control circuit 13 supplies to the switches 111, 113, and 115 switching pulses of appropriate frequency whose duty cycle is determined by the current segment and the light color of the LEDs. FIG. 5b is a schematic diagram showing the switching pulses supplied to the switch 111 (i.e., to the red-light LEDs) corresponding to the temperature segments of FIG. 5a. As illustrated, in a frame time defined by the timing signal Vsync, the duty cycle of the switching pulses produced by the control circuit to the switch 111 is gradually increased along with the rise of the temperature. As such, the number of driving pulse N_{R} applied to the red-light LEDs is also increased so as to compensate the brightness degradation of the red-light LEDs from the rising temperature. Please note that the duty cycles of the switching pulses for different switches (and, therefore, for different colored LEDs) are not necessarily identical. In addition, the duty cycles of these switching pulses may be adjusted by different amount as the temperature rises from a segment to the next higher segment. Furthermore, in FIG. 5b, the frequency of the switching pulses is identical to the frame rate of the LCD device but the switching pulses are actually not limited to this frequency only.

FIG. 5c is schematic graph showing the adjustment of the duty cycle of the switching pulse (i.e., the vertical axis) versus the temperature variation (i.e., the horizontal axis). As illustrated, when the temperature rises, the duty cycle of the switching pulses is increased in a stepwise manner. Similarly, when the temperature drops, the duty cycle of the switching pulses is decreased in the same stepwise manner. However, if the temperature fluctuates around a threshold temperature between two adjacent segments, the duty cycle of the switching pulses will be constantly changed back and forth, causing flickers of the images shown on the LCD device. An embodiment of the present method therefore adopts a hysteresis approach in adjusting the duty cycle of the switching pulses.

As shown the diagram (1) of FIG. 5d, the present embodiment increases the duty cycle immediately when the temperature rises above the threshold temperature T. However, the present embodiment decreases the duty cycle only when the temperature drop below the threshold temperature T up to a range ΔT. A variation of the present embodiment is shown in the diagram (2) of FIG. 5d. In this variation, when the temperature rises above the threshold temperature T, the duty cycle is increased gradually by a smaller step. Until the temperature is ΔT greater than the threshold temperature T, the duty cycle becomes one corresponding to the current segment. Similarly, when the temperature drops below (T+ΔT), the duty cycle is decreased gradually by the smaller step. Until the temperature is below the threshold temperature T, the duty cycle becomes one corresponding to the current segment. The variation shown in the diagram (3) is an extension of the approach shown in diagram (1) by having multiple, smaller ranges for hysteresis, instead of one. When there are a very large number of ranges, the variation shown in the diagram (3) would behave like what is shown in the diagram (4), in which the adjustment is a linear continuous one.

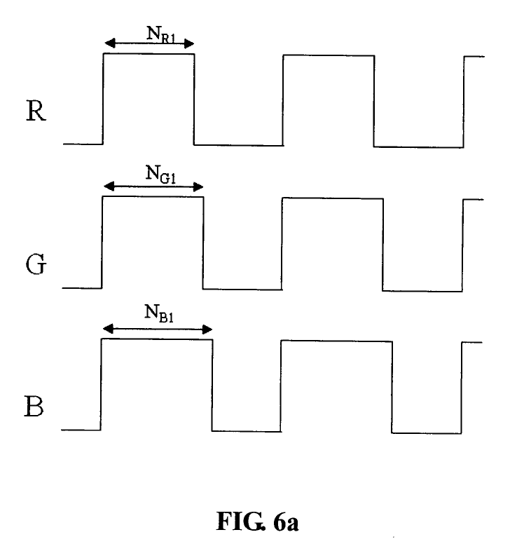

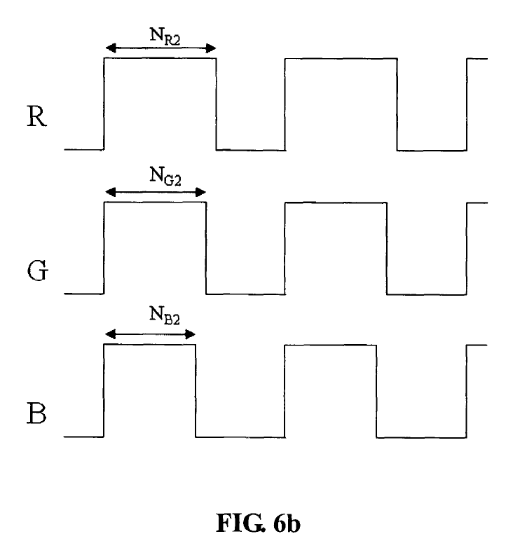

Using pulse counts to control the brightness of LEDs can be applied to produce a desired color temperature. For example, to produce white light of a high color temperature (i.e., cold color tone), the white light should have a brighter blue component and a dimmer red component. Similarly, to produce white light of a low color temperature (i.e., warm color tone), the white light should have a dimmer blue component and a brighter red component. Therefore, if the control circuit 13 produces the switching pulses shown in FIG. 6a so that the number of driving pulses applied on the red-, green-, and blue-light LEDs satisfies N_{R1}<N_{G1}<N_{B1}, white light of a cold color tone or high color temperature is obtained. Based on the same principle, if the control circuit 13 produces the switching pulses shown in FIG. 6b so that the number of driving pulses applied on the red-, green-, and blue-light LEDs satisfies N_{R2}>N_{G2}>N_{B2}, white light of a warm color tone or low color temperature is obtained. In other words, a specific color temperature is achieved by maintaining an appropriate ratio among the N_{R}, N_{G}, N_{B} values

Each driver 10 can have default N_{R}, N_{G}, N_{B} based on a pre-determined target color temperature, or a user can determine a specific color temperature via a user interface (see FIGS. 4b and 4c) provided by the driver controller 20. The setting is then configured to each driver 10 via a functional interface (see FIG. 4a) becomes the default N_{R}, N_{G}, N_{B} of the driver 10. Please note that, for simplicity, the connection between driver controller 20 and the functional interfaces of the drivers 10 is not shown in the diagram.

In addition to the brightness compensation capability to cover defect LEDs, a device according to the present invention can additionally have the capability to control color temperature as described, or the capability to dynamically adjust brightness based on the temperature, or both by the following method. The method first determines the N_{R}, N_{G}, N_{B} values of a driver 10 based on a desired color temperature and a desired brightness under a default temperature. The method also partitions the temperature range into a number of segments and each segment has corresponding one or more sets of adjustment ratios R %, G %, and B %. When the temperature varies from a first segment to an adjacent second segment, the method obtains N_{R}′, N_{G}′, N_{B}′ for the second segment by the following equations:

N_{R}′=N_{R}×R %

N_{G}′=N_{G}×G %

N_{B}′=N_{B}×B %

When the temperature rises and the brightness of LEDs degrades, a set of adjustment ratios R %, G %, and B % have their values greater than 100% so as to compensate the degraded brightness. By appropriately choosing the adjustment ratios, this method can maintain the ratio of the N_{R}′, N_{G}′, N_{B}′ values so that they will produce white light of the same color temperature even under the current higher temperature. Similarly, when the temperature drops, a set of adjustment ratios R %, G %, and B % have their values less than 100% so as to avoid brightness being too high. By appropriately choosing the adjustment ratios, this method can maintain the ratio of the N_{R}′, N_{G}′, N_{B}′ values so that they will produce white light of the same color temperature even under the current lower temperature. Please note that the aforementioned hysteresis approach can be applied to the adjustment of N_{R}, N_{G}, N_{B} as well.

As shown in FIGS. 4b and 4c and as mentioned earlier, the driver controller 20 accepts timing signals such as Vsync, DE, DCLK from the timing controller 30 of the LCD device and the timing generator of the driver controller 20 produces appropriate control signals which are delivered by the control unit to the drivers 10 stage by stage via the serial interface of FIG. 4b, or simultaneously via the parallel interface of FIG. 4c. The control unit provides a user interface for a user to configure relevant parameters (e.g., the desired color temperature). Based on these parameters, the control unit adjusts the control signals passed to the drivers 10. The control signals mainly decide when and how each driver 10 functions. Based on the parameters, the control unit would also configure the default N_{R}, N_{G}, N_{B} value for each driver 10 via its functional interface. As to how each driver 10 adjust the duty cycle of its driving pulses and the duty cycle of the switching pulses, these are conducted by each driver 10 independently (e.g., by the duty cycle calculation unit of the control circuit 13 shown in FIG. 4a). The method proposed by the present invention therefore can be viewed as being implemented partially in control unit of the driver controller 20 and partially in the control circuit 13 of each driver 10.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A driving device for a LED-based, direct-lit backlight module of a display device, said backlight module having n (n>1) LEDs as light source, said driving device comprising:
k (k>1) drivers where a said driver j (1≦j≦k) connects to mⱼ (1≦mⱼ≦n, m₁+m₂+ . . . +mₖ=n) LEDs, said mⱼ LEDs are partitioned into a plurality of sets, each set contains a plurality of LEDs, said plurality of sets of LEDs connect to said driver j by at least a current output path, said driver j contains at least a switch on each said current output path to produce periodic driving pulses by turning on and off said switch onto said plurality of LEDs connected to said current output path, said driver j further contains, for each said current output path, a feedback circuit to detect the magnitude of current on said current output path, and a pulse width controller determining a duty cycle of said driving pulses based on the detection of said feedback circuit; and
at least a driver controller where said driver controller is connected to said k drivers by an appropriate manner, said driver controller receives at least a timing signal from said LCD device and delivers appropriate control signals to said k drivers.

2. The driving device according to claim 1, wherein said display device is one of a LCD device, a plasma display device, and an OLED display device.

3. The driving device according to claim 1, wherein said appropriate manner of connection is one of a series connection and a parallel connection.

4. The driving device according to claim 1, wherein said driver j maintains a substantially constant current on said current output path by one of a constant current mechanism and a constant-voltage mechanism by adjusting said duty cycle of said driving pulses so that, when a LED is defect, the brightness of at least another set of LEDs on the same said current output path is increased.

5. A driving device for a LED-based, direct-lit backlight module of a display device, said backlight module having n (n>1) LEDs as light source, said driving device comprising:
k (k>1) drivers where a said driver j (1≦j≦k) connects to mⱼ (1≦mⱼ≦n, m₁+m₂+ . . . +mₖ=n) LEDs and at least a temperature sensor, said temperature sensor is in appropriate proximity of said mⱼ LEDs, said mⱼ LEDs are partitioned into at least three sets of red-light, green-light, and blue-light LEDs respectively, said sets of same color LEDs are connected to said driver j via at least a current output path, said driver j contains, for each said current output path, at least a first switch on said current output path to produce periodic driving pulses by turning on and off said first switch onto said sets of same color LEDs connected to said current output path, said driver j further contains, for each said current output path, a feedback circuit to detect the magnitude of current on said current output path, a pulse width controller determining a first duty cycle of said driving pulses based on the detection of said feedback circuit; and a second switch on said current output path whose turning on and off is controlled by switching pulses of an appropriate frequency and of a second duty cycle, said second duty cycle determines the number of driving pulses applied to said sets of same color LEDs via a said current output path in a specific period of time; and
at least a driver controller where said driver controller is connected to said k drivers by an appropriate manner, said driver controller receives at least a timing signal from said LCD device and delivers appropriate control signals to said k drivers.

6. The driving device according to claim 5, wherein said display device is one of a LCD device, a plasma display device, and an OLED display device.

7. The driving device according to claim 5, wherein said appropriate manner of connection is one of a series connection and a parallel connection.

8. The driving device according to claim 5, wherein said specific period of time is the frame time of said display device.

9. The driving device according to claim 5, wherein said frequency of said switching pulses is the frame rate of said display device.

10. The driving device according to claim 5, wherein said driver j, based on the temperature detected by said temperature sensor and the color of said sets of same color LEDs connected to a said current output path, increases said second duty cycle of said switching pulses of said current output path when temperature rises and decreases said second duty cycle of said switching pulses of said current output path when temperature drops.

11. The driving device according to claim 5, wherein said driver j controls said second duty cycle of said switching pulses of each current output path so that the numbers of driving pulses on all current output paths maintain an appropriate ratio based on a desired color temperature.

12. A driving device according to claim 11, wherein said driver j, based on the temperature detected by said temperature sensor, increases said second duty cycles of said switching pulses of all said current output paths while maintaining said appropriate ratio when temperature rises and decreases said second duty cycles of said switching pulses of all said current output paths while maintaining said appropriate ratio when temperature drops.

13. A driving method for a LED-based, direct-lit backlight module of a display device, said backlight module having n (n>1) LEDs as light source, said backlight module containing k (k>1) drivers, a said driver j (1≦j≦k) connecting to mⱼ (1≦mⱼ≦n, m₁+m₂+ . . . +mₖ=n) LEDs and at least a temperature sensor, said temperature sensor being positioned in appropriate proximity of said mⱼ LEDs, said mⱼ LEDs being partitioned into at least three sets of red-light, green-light, and blue-light LEDs respectively, said sets of same color LEDs being connected to said driver j via at least a current output path, said driver j containing, for each said current output path, at least a first switch on said current output path to produce periodic driving pulses by turning on and off said first switch onto said sets of same color LEDs connected to said current output path, said driver j further containing, for each said current output path, a feedback circuit to detect the magnitude of current on said current output path, a pulse width controller determining a first duty cycle of said driving pulses based on the detection of said feedback circuit; and a second switch on said current output path whose turning on and off is controlled by switching pulses of an appropriate frequency and of a second duty cycle, said second duty cycle determining the number of driving pulses applied to said sets of same color LEDs via a said current output path in a specific period of time, said backlight module further containing at least a driver controller where said driver controller is connected to said k drivers by an appropriate manner, said driver controller receiving at least a timing signal from said LCD device and delivering appropriate control signals to said k drivers; said driving method comprising the steps of:
(1) partitioning the temperature range into a plurality of contiguous segments and determining, for each said segment and based on red-, green-, and blue-light LEDs' respective brightness degradation to temperature rise, the numbers of driving pulses in a specific period of time for each of the red-, green-, and blue-light LEDs; and
(2) based on the temperature detected by said temperature sensor, the color of said sets of same color LEDs connected to a said current output path, and the number of said driving pulses for said sets of same color LEDs corresponding to a said segment where the temperature falls within, determining said second duty cycle of said switching pulses to said current output path.

14. The driving method according to claim 13, wherein said display device is one of a LCD device, a plasma display device, and an OLED display device.

15. The driving method according to claim 13, wherein said appropriate manner of connection is one of a series connection and a parallel connection.

16. The driving method according to claim 13, further comprising the step of:
(3) when the temperature detected by said temperature sensor rises into a specific range of a threshold temperature separating a said current segment and a said next segment, for each said current output path, increasing said second duty cycle so as to produce said number of driving pulses corresponding to said next segment.

17. The driving method according to claim 16, wherein said second duty cycle is increased in a stepwise manner.

18. The driving method according to claim 16, wherein said second duty cycle is increased in a continuous manner.

19. The driving method according to claim 13, further comprising the step of:
(3) when the temperature detected by said temperature sensor drops into a specific range of a threshold temperature separating a said current segment and a said previous segment, for each said current output path, decreasing said second duty cycle so as to produce said number of driving pulses corresponding to said previous segment.

20. The driving method according to claim 19, wherein said second duty cycle is decreased in a stepwise manner.

21. The driving method according to claim 19, wherein said second duty cycle is decreased in a continuous manner.

22. A driving method for a LED-based, direct-lit backlight module of a display device, said backlight module having n (n>1) LEDs as light source, said backlight module containing k (k>1) drivers, a said driver j (1≦j≦k) connecting to mⱼ (1≦mⱼ≦n, m₁+m₂+ . . . +mₖ=n) LEDs and at least a temperature sensor, said temperature sensor being positioned in appropriate proximity of said mⱼ LEDs, said mⱼ LEDs being partitioned into at least three sets of red-light, green-light, and blue-light LEDs respectively, said sets of same color LEDs being connected to said driver j via at least a current output path, said driver j containing, for each said current output path, at least a first switch on said current output path to produce periodic driving pulses by turning on and off said first switch onto said sets of same color LEDs connected to said current output path, said driver j further containing, for each said current output path, a feedback circuit to detect the magnitude of current on said current output path, a pulse width controller determining a first duty cycle of said driving pulses based on the detection of said feedback circuit; and a second switch on said current output path whose turning on and off is controlled by switching pulses of an appropriate frequency and of a second duty cycle, said second duty cycle determining the number of driving pulses applied to said sets of same color LEDs via a said current output path in a specific period of time, said backlight module further containing at least a driver controller where said driver controller is connected to said k drivers by an appropriate manner, said driver controller receiving at least a timing signal from said LCD device and delivering appropriate control signals to said k drivers; said driving method comprising the steps of:
(1) based on a desired color temperature and a desired brightness level at a default temperature, for each said current output path, determining the default numbers of said driving pulses to red-, green, and blue-light LEDs in a specific period of time at said default temperature so that a ratio of said numbers of said driving pulses conforms to the requirement of said color temperature;
(2) partitioning the temperature range into a plurality of contiguous segments, and determining, for each said segment and based on red-, green-, and blue-light LEDs' respective brightness degradation to temperature rise, the adjustment ratios to the numbers of driving pulses in a specific period of time for the red-, green-, and blue-light LEDs, respectively; and
(3) based on the temperature detected by said temperature sensor and a first said segment where said temperature falls within, calculating the new numbers of said driving pulses in a specific period of time for the red-, green-, and blue-light LEDs by applying said adjustment ratios of all segments between a second said segment where said default temperature falls within and a third segment preceding said first segment so that a ratio of said new numbers of said driving pulses conforms to the requirement of said color temperature.

23. The driving method according to claim 22, wherein said display device is one of a LCD device, a plasma display device, and an OLED display device.

24. The driving method according to claim 22, wherein said appropriate manner of connection is one of a series connection and a parallel connection.

25. The driving method according to claim 22, further comprising the step of:
(4) when the temperature detected by said temperature sensor rises into a specific range of a threshold temperature separating a said current segment and a said next-segment, for each said current output path, increasing said second duty cycle in a stepwise manner.

26. The driving method according to claim 22, further comprising the step of:
(4) when the temperature detected by said temperature sensor rises into a specific range of a threshold temperature separating a said current segment and a said next segment, for each said current output path, increasing said second duty cycle in a continuous manner.

27. The driving method according to claim 22, further comprising the step of:
(4) when the temperature detected by said temperature sensor drops into a specific range of a threshold temperature separating a said current segment and a said previous segment, for each said current output path, decreasing said second duty cycle in a stepwise manner.

28. The driving method according to claim 22, further comprising the step of:
(4) when the temperature detected by said temperature sensor drops into a specific range of a threshold temperature separating a said current segment and a said previous segment, for each said current output path, decreasing said second duty cycle in a continuous manner.
